(19) United States
(12) Patent Application Publication
(10) Pub. No.: US 2012/0274762 A1
(43) Pub. Date: Nov. 1, 2012

(54) OBTAINING DISTANCE BETWEEN DIFFERENT POINTS ON AN IMAGED OBJECT

(75) Inventors: Kuang Hu, Beijing (CN); Jian Li, Beijing (CN); Xing Xing Shen, Beijing (CN); Yun Wang, Beijing (CN); Jia Tian Zhong, Beijing (CN)

(73) Assignee: INTERNATIONAL BUSINESS MACHINES CORPORATION, Armonk, NY (US)

(21) Appl. No.: 13/454,471

(22) Filed: Apr. 24, 2012

(30) Foreign Application Priority Data
Apr. 29, 2011 (CN) 201110110185.8

(51) Int. Cl. H04N 7/18; H04N 5/232

(52) U.S. Cl. 348/135; 348/E07.085; 348/E05.045

(57) ABSTRACT

The present invention discloses an image capturing apparatus and a method for obtaining the distances between different points of an object to be shot during image capturing of said object. The method comprises: determining a pair of specified points on the object for distance measurement; focusing on each specified point respectively, and obtaining a focal length for obtaining a clear image of the specified point on an imaging device of an image capturing apparatus, a distance between the clear image point of the specified point and a longitudinal axis of a convex lens of the image capturing apparatus, and a distance between the convex lens and the imaging device of the image capturing apparatus during said focusing; and calculating a distance between the specified points in the pair on the object.

### BACKGROUND

The present invention generally relates to an image capturing apparatus, or more particularly, to an image capturing apparatus and a method for obtaining distance between different points on an imaged object.

In e-commerce, commodities are often photographed and such photos or images are then posted on websites. Customers often expect to have real sizes of the commodities displayed with such images. Currently, in order to do this, retailers in e-commerce have to do extra effort to measure the commodity size themselves and add another paragraph in the commodity description for the sizes. Retailers can also edit the images of the commodities and drawing the commodities sizes on the images after measuring the commodities sizes. It seems rather inconvenient for the retailers.

There can be other scenarios. For example, when a consumer is buying some commodities such as furniture, real estate, etc., some photos need be taken to provide more references for further considerations. Such consumers always want to know real sizes of these commodities as well. When a retailer surveys a commercial site, it is likely that the retailer would also take some pictures and gather information about site sizes of potential candidates at the same time. When a policeman takes pictures at crime scenes, he may need to obtain distances between some particular points, or sizes of some material evidences.

Under those circumstances, it is very inconvenient to measure the sizes manually. Conventionally, the size of an object to be measured can be extracted by putting a scale bar on the displaying system in an image capturing apparatus such as digital camera, digital camcorder. In this way, real size of the object is calculated using such scale bar. Nevertheless, this method requires that distances from each of two respective points for distance measurement to the photographer are the same; otherwise the distance between any two points can not be measured precisely. Furthermore, the scale bar on the displaying system might not be accurate, and it often requires users to use their naked eyes to determine the measured length relative to the scale bar, which leads to unsatisfied results such as inaccurate data or inconveniences. In addition, there is another conventional method by reconstructing a 3-dimensional model of an object by taking pictures of an object from different angles using two professional image capturing apparatus, or by taking two pictures respectively from two different angles by moving a single professional image capturing apparatus. Although such image capturing apparatus does not provide a function of measuring the object size directly, the method may obtain the object size by image capturing; however, such professional image capturing apparatus are too expensive to be affordable for normal end users.

### SUMMARY

In view of the above, when using a normal image capturing device to take pictures, there is a great need to measure size of an imaged object simultaneously and store the size information and the picture of the object together in datum of the commodity.

According to one aspect of embodiment of the present invention, a method of obtaining distances between different points on an imaged object during image capturing of the object is disclosed. The method comprises: determining a pair of specified points on the object for distance measurement; focusing on each specified point respectively, and obtaining a focal length for obtaining a clear image of the specified point on the imaging device of the image capturing apparatus, a distance between the clear image point of the specified point and a longitudinal axis of the convex lens, and a distance between the convex lens and the imaging device of the image capturing apparatus during said focusing; and calculating a distance between the specified points in the pair on the object.

According to anther aspect of embodiment of the present invention, an image capturing apparatus is disclosed. The apparatus comprises: a basic device configured to take picture, the basic device comprising a lens unit including a lens set represented by a convex lens, a camera body including an imaging device and a preview display; a receiving device configured to determine a pair of specified points on an imaged object for distance measurement; a focusing control device configured to focus on each specified point in the pair respectively, wherein the focusing control device is further configured to obtain a focal length for obtaining a clear image of the specified point on the imaging device, a distance between a clear image point of the specified point and a longitudinal axis of the convex lens, and a distance between the convex lens and the imaging device during said focusing; and a calculating device configured to calculate a distance between the specified points in the pair on the object.

### BRIEF DESCRIPTION OF THE DRAWINGS

The aforementioned and other objects, features and advantages of the embodiments of the present invention will become more apparent by further detailed descriptions of embodiments with reference to accompanying drawings, in which like reference numbers usually represent like parts in the embodiments according to the present invention.

FIG. 1 shows an imaging theory of a convex lens;

FIG. 2 shows relationships between parameters when focusing on a single point during image capturing by an image capturing apparatus;

FIG. 3 shows relationships between parameters when focusing on two points respectively during image capturing by an image capturing apparatus;

FIG. 4 shows a flow chart of a method for obtaining a distance between different points on an imaged object upon image capturing of the object;

FIG. 5 shows an embodiment for obtaining the distance between a clear image point on an imaging device of an image capturing apparatus and a longitudinal axis of a convex lens of the image capturing apparatus;

FIG. 6 shows an imaging theory of a method for obtaining distance between a convex lens and an imaging device of an image capturing apparatus; and

FIG. 7 shows a block diagram of an image capturing apparatus.

### DETAILED DESCRIPTION OF THE PREFERRED EMBODIMENTS

The preferred embodiments according to the embodiments of the present invention will be further described in details with reference to the drawings illustrating the preferred embodiments. However, the technical solution of the present invention can be embodied in various forms, and it should not be limited by the embodiments set forth herein. On contrary, those embodiments are provided to make the present invention more thorough and complete and fully convey scope of the present invention to those skilled in the art.

Imaging Theory of an Image Capturing Apparatus:

The image capturing apparatus herein refers to various image capturing apparatus which images objects in accordance with an imaging theory of a convex lens, including cameras, image pickup device with a focusing function, video recording apparatus or the like.

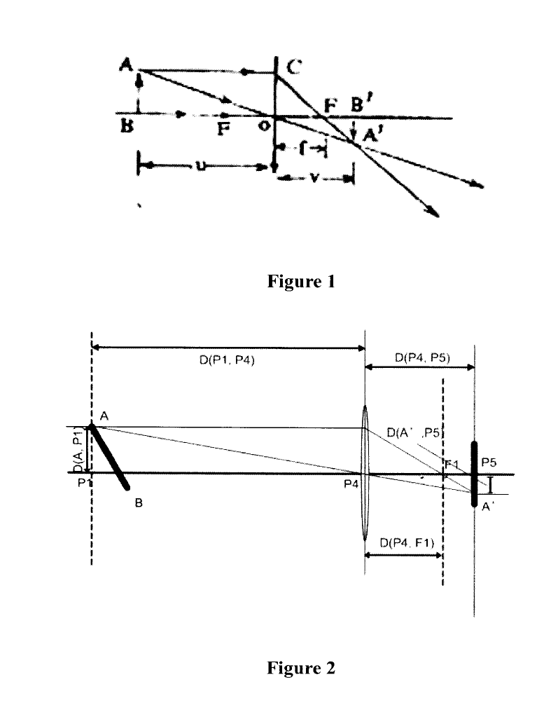

The imaging theory of an image capturing apparatus is actually an imaging theory of a convex lens. FIG. 1 shows the imaging theory of a convex lens. In FIG. 1, f represents a focal length of the convex lens, u represents an object distance from the convex lens, v represents an image distance from the convex lens. The imaging theory of the convex lens satisfy following equation:

1/f=1/u+1/v (1)

Theoretical basis for obtaining a distance between two points on an imaged object during image capturing by the image capturing apparatus will be described as below.

Currently, most of the image capturing apparatuses have auto-focusing function, in other words, they can automatically focus on a certain point of the image. Auto-focusing may select a foci band upon imaging and an image pickup device with focusing function can adjust the foci band). Since the foci band of the image capturing apparatus and the focal length of the convex lens have a one-to-one correspondence, the focal length of the convex lens can be determined by obtaining the foci band during image capturing by the image capturing apparatus.

FIG. 2 shows relationships between parameters when focusing on a single point during image capturing by an image capturing apparatus. Assuming that the imaging capturing apparatus need determine a length D(A, B) of an object AB (in the embodiment of the present invention, D(X1, X2) represents a distance between point X1 and point X2), a distance between an end point A and the image capturing apparatus may be different from a distance between an end point B and the image capturing apparatus. According to FIG. 2, when focusing on the end point A, the focus length can be obtained by the image capturing apparatus. By focusing, a distance D(A′, P5) from a clear image point A′ of the end point A on an imaging device of the image capturing apparatus to a longitudinal axis of the convex lens can be obtained by the image capturing apparatus (Details will be described later), and a distance D(P4, P5) between the convex lens and the imaging device of the image capturing apparatus can be obtained by the image capturing apparatus (Details will be described later). Based on a focal length D(P4, F1) of the image capturing apparatus, a distance D(P1, P4) between the convex lens and the plane perpendicular to the longitudinal axis of the convex lens on which the point A is positioned (in other words, the projection point of the point A on the longitudinal axis of the convex lens) can be calculated as following:

1/D(P4,F1)=1/D(P1,P4)+1/D(P4,P5) (2)

D(P1,P4)=1/[1/D(P4,F1)−1/D(P4,P5)] (3)

According to principle of similar triangles, the distance D(A, P1) between the point A and the longitudinal axis of the convex lens can be calculated as following:

D(A,P1)/D(A′,P5)=D(P1,P4)/D(P4,P5) (4)

D(A,P1)=D(P1,P4)*D(A′,P5)/D(P4,P5) (5)

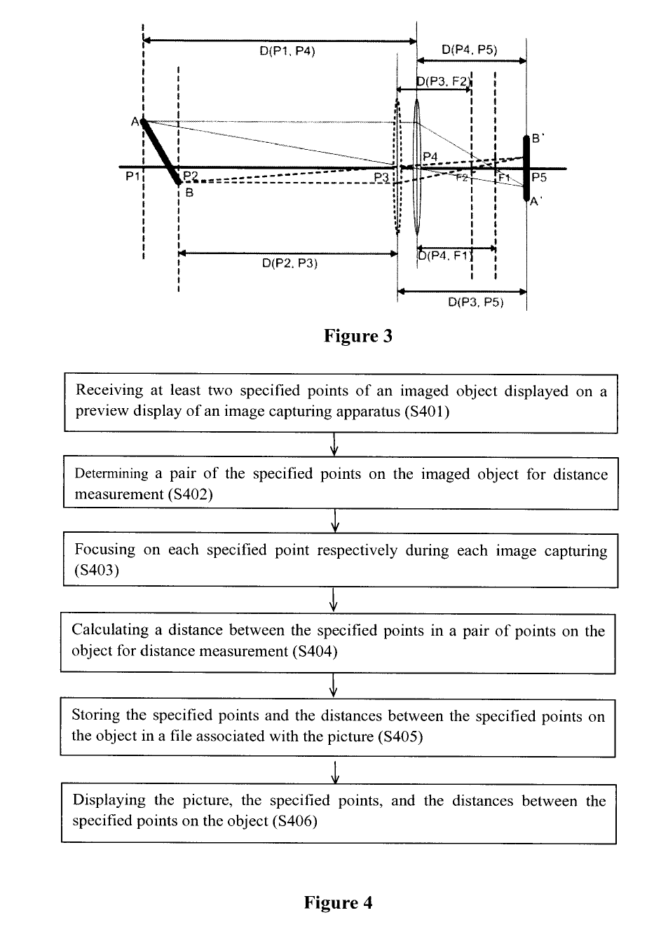

FIG. 3 shows relationships between parameters when focusing on two points respectively during image capturing by an image capturing apparatus. As shown in FIG. 3, when focusing on another point B, auto focusing can produce a clear image point B′ of the point B on the imaging device by a slight displacement of a lens unit of the image capturing apparatus. Similar to the focusing for point A, a distance D (P2, P3) between the convex lens and the plane on which the point B resides (in other words, the projection point of point B on the longitudinal axis of the convex lens), and the distance D(B, P2) between the point B and the longitudinal axis of the convex lens can be calculated as following:

1/D(P3,F2)=1/D(P2,P3)+1/D(P3,P5) (6)

D(P2,P3)=1/[1/D(P3,F2)−1/D(P3,P5)] (7)

D(B,P2)/D(B′,P5)=D(P2,P3)/D(P3,P5) (8)

D(B,P2)=D(P2,P3)*D(B′,P5)/D(P3,P5) (9)

A distance between the projections points of the point A and B on the longitudinal axis of the convex lens, namely a distance D (P1, P2) between P1 and P2, can also be obtained as following:

D(P1,P2)=[D(P1,P4)+D(P4,P5)]−[D(P2,P3)+D(P3,P5)] (10)

The length D(A, B) of the object AB can then be obtained as following:

D(A,B)²=D(P1,P2)²+[D(A,P1)+D(B,P2)]² (11)

FIG. 4 shows a flow chart of a method for obtaining a distance between different points on an imaged object upon image capturing of the object.

In accordance of FIG. 4, at step S401, at least two specified points of an imaged object displayed on a preview display such as a viewfinder of an image capturing apparatus is received. The viewfinder can be a display of a digital camera. The picture to be taken can be previewed on the viewfinder prior to image capturing. The specified points can be selected on the viewfinder by an user's input. This can be performed on a picture displayed on the viewfinder when the photographer prepares to take the picture. If it is considered as inconvenient to select the specified points on the viewfinder while holding up the image capturing apparatus upon taking pictures of an object, a pre-fetch mode can be added to the image capturing apparatus, in which a stationary picture is taken and displayed on the viewfinder without updating even if the image capturing apparatus is moved, and the data of this stationary picture is not stored permanently but may be stored in a temporary storage, or even if it is stored in a permanent storage, the data is overwritten in a subsequent normal shooting mode. There are a number of ways to select the above mentioned specified points. For example, an user can select on a touch screen of the viewfinder. Alternatively, a mouse can be provided on a screen of the viewfinder and the user can select the specified points by moving the mouse. Alternatively, a user interface can be provided for the user and the user can input coordinates of the specified points on the screen.

At step S402, a pair of the specified points on the imaged object for distance measurement is determined. If only two specified points are received, it is by default to measure a distance between the two specified points. If there are more than two specified points, it is necessary to specify which pair of points for distance measurement. The method to specify the pair of points for distance measurement is similar to the way for specifying the points. The user can directly draw a line between the two points on the touch screen to specify the pair of points for distance measurement when selecting points on the touch screen of the viewfinder. When selecting the points by a mouse, the user can link the two points using the mouse on the screen of the viewfinder in order to specify the pair of points for distance measurement. When selecting points by inputting coordinates on the screen of the viewfinder, the user can input a pair of coordinates of two respective points to specify the pair of points for distance measurement. In one embodiment, step S401 for receiving the specified points and step S402 for determining a pair of specified points for distance measurement can be completed in a single reception process. For example, a user may directly draw a line segment on a touch screen of the viewfinder, so that both ends of line segment can be identified as the specified points, and the physical distance corresponding to the line segment can be identified as the distance between the specified points on the imaged object.

At step S403, the image capturing apparatus focus on each specified point respectively during each image capturing. During focusing on each specified point, a focal length for obtaining a clear image of the specified point on the imaging device of the image capturing apparatus, a distance between the clear image point of the specified point and the longitudinal axis of the convex lens of the image capturing apparatus, and a distance between the convex lens of the image capturing apparatus and the imaging device of the image capturing apparatus are obtained. The process of focusing on each specified point by the image capturing apparatus is carried out during a formal image capturing process, i.e., after a shot button is pressed by the user. The user may press the button once to trigger a sequential auto-focusing on each specified point controlled by a focusing control device within the image capturing apparatus. Therefore, such image capturing process might last longer than a normal image capturing process after the shot button is pressed. In another embodiment, a particular measuring mode can be set for the image capturing apparatus. In such mode, it is allowed to press the shot button for a plurality of times. Each time the shot button is pressed, the image capturing apparatus focus on one of the specified points. Alternatively, the correspondence between number of times for the pressing the shot button and the process of focusing on the specified points can be specified. The hands of the user holding the image capturing apparatus should not move under any circumstances, in order to avoid a position change of the image capturing apparatus, which might in turn changes the imaging position. Preferably, a tripod can be used to keep a constant position of the image capturing apparatus in order to keep the imaging position stable. The image capturing apparatus typically comprises a plurality of sets of lenses, yet they can be optically converted to a single convex lens eventually. With parameters of focusing determined, relative positions of the respective lenses within the image capturing apparatus are set, which determines the focal length of the convex lens. Currently many types of image capturing apparatus are capable of recording the focal length automatically. In addition, if the number of the specified points is more than two, for example, in case that there are three specified points A, B and C, and the distances between AB and BC need to be measured, it is only necessary to focus on point B once instead of twice, although point B is specified twice when determining which two points for distance measurement.

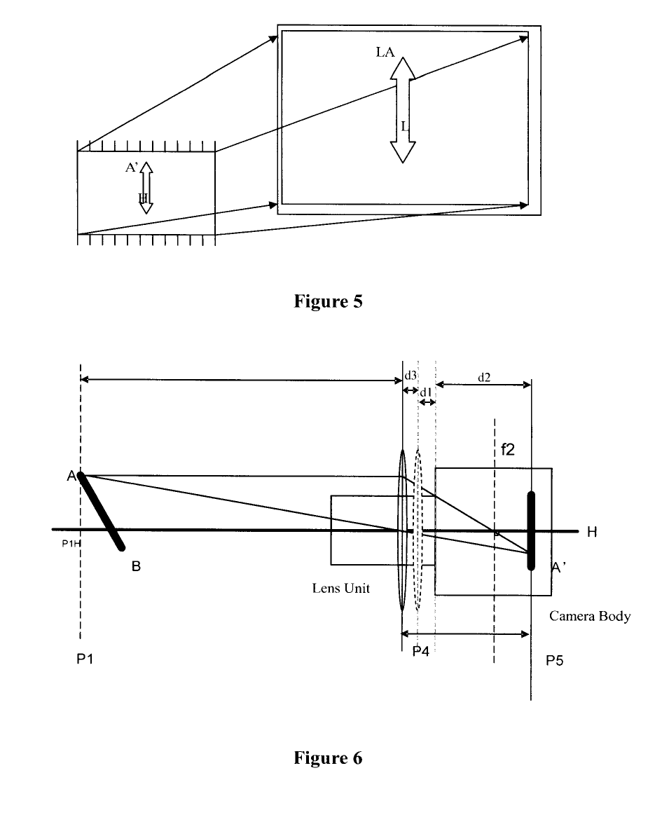

There are various ways to obtain the distance between the clear image point on the imaging device of the image capturing apparatus and the longitudinal axis of the convex lens of the image capturing apparatus. FIG. 5 illustrates an embodiment of obtaining the distance between the clear image point on the imaging device of the image capturing apparatus and the longitudinal axis of the convex lens of the image capturing apparatus, in which the distance is obtained by a distance between the displayed point of the specified point on the preview display of the image capturing apparatus and the center of the preview display, multiplied by a length ratio of the image on the imaging device to the image on the preview display upon image capturing of the sane object. As shown in FIG. 5, the imaging device of the image capturing apparatus, such as CMOS/CCD located on the image plane is on left side and the preview display of the image capturing apparatus is on right side. The imaging device converts optical signals into electrical signals based on photoelectric effect, then the optical image on the imaging device is displayed on the preview display. Therefore, the optical image on the imaging device is enlarged in a scale on the preview display (the preview display of the image capturing apparatus is usually larger than the image device). Assuming that the length ratio of the image on the image device to the image displayed on the preview display for the same object is d/D (which can be recorded in a storage of the image capturing apparatus as a parameter), a point LA on the preview display corresponds to a point A′ on the image device, a distance between LA and the center of the display is L, and a distance between A′ and the center of the image device is H, then,

H=L*d/D (12)

In a further embodiment of obtaining the distance between the clear image point on the imaging device of the image capturing apparatus and the longitudinal axis of the convex lens of the image capturing apparatus, the image device, such as CMOS/CCD is an array of sensing points with each sensing point assuming a square shape. The image capturing apparatus can record side length of each sensing points within the array. A processor of the image capturing apparatus can obtain the above distance by multiplying number of the sensing points between the clear image point of the specified point on the imaging device and the center of the imaging device with the side length of the square representing a sensing point.

The distance between the convex lens and the imaging device of the image capturing apparatus, i.e. D (P4, P5) shown in FIG. 3, can be measured with various methods depending on the image capturing apparatus. A dedicated measuring device can be developed in the image capturing apparatus to measure the distance in order to provide a high accuracy. The embodiment of the present invention provides another method, with its principle illustrated in FIG. 6. As shown in FIG. 6, the image capturing apparatus comprises a lens unit comprising a convex lens representing whole lens set and a camera body containing the image device. In this method, it is necessary to measure three distances as following: (1) an initial distance d1 from the convex lens at a rear position to back of the lens unit, which is a constant once the focusing parameters of the lens unit are set (such correspondence can be stored for subsequent access); (2) a distance d2 from the back of the lens unit to the image device within the camera body, which varies according to different specifications of the camera body (for example, a distance from the back of the lens unit to the imaging device is smaller in a camera body for APS-C frame than in a camera body for a full frame due to smaller image device), and corresponds to specification of camera body and can be burned into the a memory device in the camera body for subsequent access; (3) displacement distance d3 for obtaining a clear image of an object plane during auto-focusing by moving the convex lens. Currently during auto-focusing, the displacement distance of the lens set is first calculated by a software program and then the lens set is driven by a motor accordingly; therefore the displacement distance of the lens set can be obtained during auto-focusing. According to FIG. 6, D (P4, P5)=d1+d2+d3. For less complicated low level digital cameras, the lens unit and the camera body are integrated, therefore the data can be obtained more easily.

Referring back to FIG. 4, at step S404, a distance between the specified points in a pair of points on the object for distance measurement is calculated. Such calculation requires the parameters obtained by the step S403 in order to calculate the distances between each specified point in the pair and the longitudinal axis of the convex lens of the image capturing apparatus during focusing, and the distances between each specified point in the pair and the convex lens of the image capturing apparatus, then the distance between the specified points in the pair on the object can be calculated. According to the theories described above, the calculations can be performed by a module within the image capturing apparatus running a processing program.

In a preferred embodiment, if the image capturing apparatus is a digital device, the method can further comprise a step S405, in which the specified points and the distances between the specified points on the object are stored in a file associated with the picture. Conventionally only pixel information is included in the stored file of a picture taken by the image capturing apparatus. In comparison, in the embodiment of the present invention, the specified points and the distances between the specified points on the object can also be saved together with the pixel information in the picture file. For example, the specified points and the distance between the specified points on the object can be stored in a file as shown in Table 1, and then link the file as shown in Table 1 to the original picture file containing pixel information. One method for establishing the link of two files is by using the same file name but different extension name. Other methods are also possible, for example, by creating a dedicated link table and looking up the link table upon displaying the information. If an agreement could be reached across industry, the original pixel file can also be expanded in order to embed the information as shown in Table 1 directly into the pixel file via a standard interface. Herein, Table 1 is only one exemplary embodiment of recording the specified points and the distances between the specified points on the object. Those skilled in the art can use various recording methods, such as using arrays, linked list or the like.

TABLE 1
Recording specified points and the distances between
the specified points on an object using a table

| | Coordinate of | Coordinate of | |
|---|---|---|---|
| No. | First Point | Second Point | Length |
| 1 | (x1, y1) | (x2, y2) | 10 mm |
| 2 | (x3, y3) | (x4, y4) | 20 mm |
| 3 | . . . | . . . | . . . |

In another preferred embodiment, at step S406, a request for displaying the picture is received so that the picture, the specified points recorded in the picture, and the distances between the specified points on the object are displayed. The specified points recorded in the picture, and the distance between the specified points on the object, that is, any two specified points and the line segment between these two points can be assigned a specified color, such as red or black, with the length value of the line segment displayed at the proximity of the line segment. Sometimes, the color of the picture and the specified color are relatively close, which might lead to a poor display quality. In this case, it is prefer to identify primary colors of a portion of picture on which the two specified points and the line segment therebetween are shown first, and then assign a color with relatively high contrast with respect to the primary colors in chromatics to the specified color, in order to make the displayed information more clear.

The embodiment of the present invention may comprise an image capturing apparatus. As shown in FIG. 7, an image capturing apparatus 700 comprises a basic element 704 for taking pictures of an object. The basic element 704 may comprise a lens unit comprising a lens set represented by a convex lens, focusing device and imaging device such imaging sensor or the like. The image capturing apparatus 700 further comprises a receiver 701 configured to determine a pair of specified points on the object for distance measurement; and a focusing control device 702 configured to focus on each specified point. During focusing on each specified point, the focusing control device 702 is further configured to obtain a focal length for obtaining a clear image of the specified point on the imaging device, distances between the clear image point of each specified point and the longitudinal axis of the convex lens of the image capturing apparatus, and distance between the convex lens of the image capturing apparatus and the imaging devices. The image capturing apparatus 700 can further comprise a calculating device 703 configured to calculate the distance between the specified points on the object. Preferably, the receiver 701 is also configured to receive at least two specified points of the object displayed on a preview display such as a viewfinder of the image capturing apparatus.

In FIG. 7, the calculating device 703 uses the focal length for obtaining a clear image of the specified point on the imaging device, the distances between the clear image point of each specified point and the longitudinal axis of the convex lens of the image capturing apparatus, and the distance between the convex lens of the image capturing apparatus and the imaging devices to calculate the distances between each specified point and the longitudinal axis of the convex lens of the image capturing apparatus during focusing, as well as the distances between each specified point and the convex lens of the image capturing apparatus, in order to calculate the distance between the specified points on the object.

In an embodiment, the focusing control device obtains the distance between the clear image point on the imaging device of the image capturing apparatus and the longitudinal axis of the convex lens of the image capturing apparatus by one of the following ways: (1) obtaining a distance between the displayed point on the preview display of the image capturing apparatus and the center of the preview display, and multiplying the distance with length ratio of the image on the image device to the image on the preview display for the same object; (2) obtaining number of sensing points between the clear image point of the specified point on the imaging device of the image capturing apparatus and the center of the imaging device, and multiplying the number with side length of a square representing the sensing point of the imaging device. In another embodiment, the distance between the convex lens of the image capturing apparatus and the imaging device of the image capturing apparatus can be obtained by summing an initial distance from a rear position of the convex lens representing the lens set of the lens unit to back of the lens unit, a distance from the back of the lens unit to the imaging device, and a displacement distance of the lens set for obtaining a clear image on an object plane during auto-focusing.

In an embodiment, the image capturing apparatus further comprises a storage device (not shown in FIG. 5), configured to store the specified points and the distances between the specified points in a file associated with a picture.

In another embodiment, the image capturing apparatus further comprises a display device (not shown in FIG. 5), configured to receive a request for displaying a picture, and display the picture, the specified points and the distances between the specified points on the object recorded in the file associated with the picture.

In an embodiment, the receiving device receives at least two specified points of the object displayed on the preview display of the image capturing apparatus by one of following ways: (1) receiving the specified points from a touch screen of the preview display of the image capturing apparatus; (2) receiving the specified points from mouse inputs provided on the screen of the preview display of the image capturing apparatus; (3) receiving the specified points from the user interface provided on the screen of the preview display of the image capturing apparatus.

In another embodiment, the receiving device determines a pair of specified points on the object for distance measurement by one of the following ways: (1) drawing a line between the two specified points on a touch screen of the preview display of the image capturing apparatus; (2) linking the two specified points on a screen of the preview display of the image capturing apparatus using a mouse; (3) inputting coordinates of the specified points on a screen of the preview display of the image capturing apparatus.

While the exemplary embodiments in accordance to the present invention have been described with reference to the drawings, it should be appreciated that the present invention should not be limited to the exact embodiments. Those skilled in the art can modify the embodiments in various modifications to the embodiments without departing the scope and the spirit of the embodiment of the present invention. All such variations and modifications are intended to fall within the scope of the present invention defined in the attached claims.

What is claimed is:

1. A method of obtaining distances between different points on an imaged object during image capturing of the object, the method comprising:
determining a pair of specified points on the object for distance measurement;
focusing on each specified point respectively, and obtaining a focal length for obtaining a clear image of the specified point on an imaging device of an image capturing apparatus, a distance between the clear image point of the specified point and a longitudinal axis of a convex lens of the image capturing apparatus, and a distance between the convex lens and the imaging device of the image capturing apparatus during said focusing; and
calculating a distance between the specified points in the pair on the object.

2. A method according to claim 1, wherein said calculating the distance between the specified points in the pair on the object comprises: using the focal lengths for obtaining the clear images of the specified points on the imaging device of the image capturing apparatus, the distances between the clear image points of the specified points and a longitudinal axis of a convex lens, and the distance between the convex lens and the imaging device of the image capturing apparatus obtained during said focusing so as to calculate distances between each specified point in the pair and the longitudinal axis of the convex lens during focusing, and distances between each specified point in the pair and the convex lens during focusing.

3. A method according to claim 2, wherein said calculating the distance between the specified points in the pair on the object utilize following equation:
D(A,B)²=D(P1,P2)²+[D(A,P1)+D(B,P2)]²
in which A, B are two specified points in the pair, D(A, B) represents a distance between A and B on the object, D(P1, P2) represents a distance between the projections of A and B on the longitudinal axis of the convex lens, D (A, P1) represents a distance between A and the longitudinal axis of the convex lens, D(B, P2) represents the distance between B and the longitudinal axis of the convex lens,
wherein D(P1, P2) is calculated from the distance between the convex lens and the imaging device of the image capturing apparatus and the distances between each specified point in the pair and the convex lens during focusing.

4. A method according to claim 1, further comprising: receiving at least two specified points of the imaged object displayed on a preview display of the image capturing apparatus.

5. A method according to claim 2, wherein the distance between the clear image point of each specified point on the imaging device of the image capturing apparatus and the longitudinal axis of the convex lens is obtained by one of following methods:
obtaining a distance between a displayed point of the specified point on a preview display of the image capturing apparatus and the center of the display, and multiplied the distance by a length ratio of an image on the imaging device to an image on the preview display for the same object during image capturing;
obtaining number of sensing points from the clear image point of the specified point on the imaging device to the center of the imaging device, and multiplied the number by side length of a square representing each sensing point.

6. A method according to claim 2, wherein the distance between the convex lens and the imaging device of the image capturing apparatus is obtained by summing an initial distance from a rear position of the convex lens to back of a lens unit, a distance from the back of the lens unit to the imaging device, and a displacement distance of the convex lens for obtaining a clear image on an object plane during auto-focusing.

7. A method according to claim 1, further comprising: storing the specified points and the distance between the specified points in a pair into a picture taken during image capturing of the object.

8. A method according to claim 7, further comprising: receiving a request for displaying the picture; and displaying the picture, the specified points on the object recorded in the picture and the distance between the specified points in the pair on the object recorded in the picture.

9. A method according to claim 4, wherein the at least two specified points of the object displayed on the preview display of the image capturing apparatus are obtained by one of following methods:
receiving the specified points from a touch screen of the preview display of the image capturing apparatus;
receiving the specified points from a mouse input provided on a screen of the preview display of the image capturing apparatus; and
receiving the specified points from input of an user interface provided on a screen of the preview display of the image capturing apparatus.

10. A method according to claim 9, wherein the specified points in the pair for distance measurement is determined by one of following methods:
drawing a line between the two specified points on the touch screen of the preview display of the image capturing apparatus;
linking the two specified points on the screen of the preview display using the mouse;
inputting coordinates of the two specified points on the screen of the preview display of the image capturing apparatus.

11. An image capturing apparatus, comprising:
a basic device configured to take picture;
a receiving device configured to determine a pair of specified points on an imaged object for distance measurement;
a focusing control device configured to focus on each specified point in the pair respectively, wherein the focusing control device is further configured to obtain a focal length for obtaining a clear image of the specified point on an imaging device of the image capturing apparatus, a distance between a clear image point of the specified point and a longitudinal axis of a convex lens of the image capturing apparatus, and a distance between the convex lens and the imaging device of the image capturing apparatus during said focusing; and
a calculating device configured to calculate a distance between the specified points in the pair on the object.

12. An image capturing apparatus according to claim 11, wherein the calculating device uses the focal length for obtaining the clear image of the specified point on the imaging device, the distance between the clear image point of the specified point and the longitudinal axis of the convex lens, and the distance between the convex lens and the imaging device obtained by the focusing control device so as to calculate distances between each specified point in the pair and the longitudinal axis of the convex lens during focusing, and distances between each specified point in the pair and the convex lens, in order to calculate the distance between the specified points in the pair on the object.

13. An image capturing apparatus according to claim 12, wherein the calculating device calculates the distance between the specified points in the pair on the object using following equation:
D(A,B)²=D(P1,P2)²+[D(A,P1)+D(B,P2)]²
in which A, B are two specified points in the pair, D(A, B) represents the distance between A and B, D(P1, P2) represents a distance between the projections of A and B on the longitudinal axis of the convex lens of the image capturing apparatus, D (A, P1) represents a distance between A and the longitudinal axis of the convex lens, D(B, P2) represents the distance between B and the longitudinal axis of the convex lens,
wherein D(P1, P2) is calculated from the distance between the convex lens and the imaging device and the distances between each specified point in the pair and the convex lens during focusing.

14. An image capturing apparatus according to claim 11, wherein the receiving device is further configured to receive at least two specified points on the imaged object displayed on the preview display of the image capturing apparatus.

15. An image capturing apparatus according to claim 12, wherein the focusing control device obtains the distance between the clear image point of each specified point on the imaging device and the longitudinal axis of the convex lens with one of following methods:
obtaining a distance between a displayed point of the specified point on the preview display of the image capturing apparatus and the center of the display, and multiplied the distance by a length ratio of an image on the imaging device to an image on the preview display for the same object during image capturing;
obtaining number of sensing points from the clear image point of the specified point on the imaging device to the center of the imaging device, and multiplied the number by side length of a square representing each sensing point.

16. An image capturing apparatus according to claim 12, wherein the focusing control device obtains the distance between the convex lens and the imaging device by summing an initial distance from a rear position of the convex lens to back of a lens unit, a distance from the back of the lens unit to the imaging device, and a displacement distance of the lens set for obtaining a clear image on an object plane during auto-focusing.

17. An image capturing apparatus according to claim 11, further comprising:
A storage device configured to store the specified points and the distances between the points of the specified point pairs into a file associated with the picture.

18. An image capturing apparatus according to claim 17, further comprising:
a display configured to configured to receive a request for displaying a picture, and display the picture, the specified points and the distances between the specified points on the object recorded in the file associated with the picture

19. An image capturing apparatus according to claim 14, wherein the receiving device receives at least two specified points of the object displayed on the preview display of the image capturing apparatus by one of following ways:
(1) receiving the specified points from a touch screen of the preview display of the image capturing apparatus;
(2) receiving the specified points from a mouse input provided on a screen of the preview display of the image capturing apparatus;
(3) receiving the specified points from input of a user interface provided on a screen of the preview display of the image capturing apparatus.

20. An image capturing apparatus according to claim 19, wherein the receiving device determines a pair of specified points on the object for distance measurement by one of the following ways:
(1) drawing a line between the two specified points on a touch screen of the preview display of the image capturing apparatus;
(2) linking the two specified points on a screen of the preview display of the image capturing apparatus using a mouse;
(3) inputting coordinates of the two specified points on a screen of the preview display of the image capturing apparatus.
